(19) United States
(12) Patent Application Publication
(10) Pub. No.: US 2020/0097529 A1
(43) Pub. Date: Mar. 26, 2020

(54) SYSTEM AND METHOD FOR ENHANCING EFFICIENCY OF ADDING AND DISPLAYING CONTENT IN DIGITAL MEDIA

(71) Applicant: Key Understanding LLC, Claremont, CA (US)

(72) Inventors: Jennifer Gomez, Claremont, CA (US); Martha B. Stein, Claremont, CA (US); Jonathan Kula, Claremont, CA (US)

(21) Appl. No.: 16/575,310

(22) Filed: Sep. 18, 2019

Related U.S. Application Data
(60) Provisional application No. 62/734,633, filed on Sep. 21, 2018.

(51) Int. Cl. G06F 17/24; G06F 3/0484; G06F 9/451; G06F 9/54

(52) U.S. Cl. CPC G06F 17/24; G06F 3/0484; G06F 3/0482; G06F 9/543; G06F 9/451

(57) ABSTRACT

Aspects of the disclosure relate to a system and method for enhancing efficiency of adding and displaying content in digital media. In one embodiment, the system and method may include receiving digital content and an indication of a keystroke corresponding to the digital content, generating a mapping between the digital content and the keystroke, and utilizing a clipboard function to insert the digital content into the document upon receiving another indication of the keystroke. Other aspects, embodiments, and features are also claimed and described.

### CROSS REFERENCE TO RELATED APPLICATIONS

The present application claims the benefit of priority under 35 U.S.C. § 119 to U.S. Provisional Application No. 62/734,633 entitled, “SYSTEM AND METHOD FOR ENHANCING EFFICIENCY OF ADDING AND DISPLAYING CONTENT IN DIGITAL MEDIA,” filed Sep. 21, 2018 which is incorporated by reference herein.

### FIELD

The technology discussed below relates generally to shortcut enabled information management or, more specifically, methods, systems, and products for editing, annotating, adding, constructing, and commanding digital media.

### BACKGROUND

A clipboard function is a temporary storage area utilized by users and application software to hold data that has been cut or copied from another location. When a user edits a document, data that is cut or copied is typically stored by the clipboard function. The data stored in the clipboard is suitably pasted into another folder, document, or location within the same computer or other documents, apps, etc. However, clipboard functions generally have limited memory and storage resources. Clipboard functions generally limit the amount of data that can be stored, the type of data that can be stored, and the shortcut keys available to paste the data. In some cases, a user will be required to make repetitive edits or updates to documents or other applications that require a large volume of diverse data. The storage and shortcut key limitations may not support such a task. This shortcoming of the clipboard function may prolong the time required for the user to enter repeat data.

Thus, it is preferable to streamline the insertion of oft-used data into digital media.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example, a method of editing content in a document by an apparatus includes generating, by a web browser extension, a user-defined keyboard, wherein generating the user-defined keyboard includes obtaining, via a user interface, a first keystroke, and associating the first keystroke with a first digital content, and storing the user-defined keyboard in an electronic memory device. Other examples of use may be inserting data into search boxes, forms, having a keystroke relate to a function, etc.

In one aspect, the method may include executing, by a processor included by the apparatus, a web browser, launching, via the web browser, a clipboard interface function by the web browser extension, wherein the clipboard interface function is configured to modify an operation of a resident clipboard function included by the web browser, and a web-based program configured to accept user input (some examples include: a document, a form, a search bar, a spreadsheet, etc.) Upon invocation of the first keystroke, the web browser extension may retrieve the stored user-defined keyboard, and using the clipboard interface function, may insert the first digital content corresponding to the first keystroke.

In another aspect, the user-defined keyboard includes obtaining, via the user interface, a second keystroke, associating the second keystroke with a second digital content, wherein the web browser extension includes a randomization function configured to randomly insert one of the first digital content or the second digital content into the document upon receiving an invocation of a third keystroke corresponding to the randomization function.

In another aspect, the web browser extension includes a count function configured to maintain a count of a number of times the first digital content has been inserted into the document. In another aspect, the electronic memory device is resident to one or more of: (i) a local hard drive storing what is shown in the user interface, or (ii) a remote internet server. In another aspect, generating the user-defined keyboard includes obtaining, via the user interface, a second keystroke, associating the second keystroke with a second digital content, and storing the user defined keyboard in a remote server. Another aspect includes communicating a request to the remote internet server, wherein the request is configured to retrieve the user-defined keyboard, retrieving, by the web browser extension, the stored user-defined keyboard, and utilizing the clipboard interface function to insert the first digital content or the second digital content into the document upon receiving an invocation of the first keystroke or the second keystroke, wherein the first digital content or the second digital content is retrieved from the remote server.

In one example, an apparatus for inserting digital content into a computer program accepting user input may include means for generating a user-defined keyboard, wherein the means for generating the user-defined keyboard includes: means for obtaining a first keystroke, and means for associating the first keystroke with a first digital content; and means for storing the user-defined keyboard in an electronic memory device.

In one example, a non-transitory computer-readable medium storing computer-executable code, may include code for causing a computer to: generate a user-defined keyboard, wherein generating the user-defined keyboard includes: obtaining a first keystroke, and associating the first keystroke with a first digital content, and storing the user-defined keyboard in an electronic memory device.

In one example, an apparatus for editing content in a document, includes a processor, a transceiver communicatively coupled to at least one processor, and a memory communicatively coupled to the at least one processor, wherein the processor is configured to: generate a user-defined keyboard, wherein generating the user-defined keyboard includes: obtaining a first keystroke, and associating the first keystroke with a first digital content, and store the user-defined keyboard in an electronic memory device.

In one example a method for inserting digital content into a computer program accepting user input is disclosed. The method includes receiving digital content and an indication of a keystroke corresponding to the digital content, generating a mapping between the digital content and the keystroke, and utilizing a clipboard function to insert the digital content into the aforementioned program upon receiving another indication of the keystroke.

In one example, the method may also include displaying the document on a monitor, receiving an indication of a location within the document, and inserting the digital content into the document based on the location. In another example, the document is hosted by a web-application and displayed on a monitor via a web browser, and the clipboard function is a function of the operating system and/or any program executable by the operating system such as a web browser, and a web browser extension utilizes the clipboard function of the web browser to insert the digital content into the document. In another example, the method may include a web-hosted form, displayed on the monitor via a web-browser, and, upon the invocation of a first keystroke, a web browser extension utilizes the clipboard function of the operating system to insert the first digital content into the form on behalf of the user. In another example, the method includes storing the digital content, the key stroke, and the mapping between the digital content and the keystroke in a first memory, wherein the first memory is separate from a second memory associated with the clipboard function of the web browser. In another example, the method includes storing a first digital content corresponding to a first keystroke, storing a second digital content corresponding to a second keystroke, receiving an indication of a randomization function, and randomly inserting one of the first digital content or the second digital content into the document upon receiving an indication of a third keystroke corresponding to the randomization function. In another example, the method includes maintaining a count of a number of times the digital content has been inserted into the document.

In one example, an apparatus for inserting content into a computer program accepting user input is disclosed. The apparatus include a means for receiving digital content and an indication of a keystroke corresponding to the digital content, a means for generating a mapping between the digital content and the keystroke, and a means for utilizing a clipboard function to insert the digital content into the computer program upon receiving another indication of the keystroke.

In one example, a non-transitory computer-readable medium storing computer-executable code is disclosed. The executable code may cause a computer to receive digital content and an indication of a keystroke corresponding to the digital content, generate a mapping between the digital content and the keystroke, and utilize a clipboard function to insert the digital content into the document upon receiving another indication of the keystroke.

In one example, an apparatus for editing content in a document is disclosed. The apparatus may include a processor, a transceiver communicatively coupled to the at least one processor, and a memory communicatively coupled to the at least one processor, wherein the processor is configured to receive digital content and an indication of a keystroke corresponding to the digital content, generate a mapping between the digital content and the keystroke, and utilize a clipboard function to insert the digital content into the document upon receiving another indication of the keystroke.

In one example, a user may have the option to establish identity as a local user, by which the user will not be required to have or maintain an online presence. By using the local user option, the user may be restricted to information that is stored in the local memory such as user-defined information on a local disk or cached credentials acquired from previous use. This provides a benefit that allows a user to utilize the clipboard function offline, and/or without the previous use of an internet/intranet connection.

In one example, this disclosure may relate to a method of editing content in a document by an apparatus, including generating a user-defined keyboard, wherein generating the user-defined keyboard, obtaining, via a user interface, a first keystroke, and associating the first keystroke with a first digital content, and storing the user-defined keyboard in an electronic memory device. In another example, the method may include executing, by a processor included by the apparatus, a computer executable program containing a clipboard interface function, wherein the clipboard interface function is configured to modify an operation of a resident clipboard function included by an operating system, retrieving, by the computer executable program, the stored user-defined keyboard, and utilizing the clipboard interface function to insert the first digital content into a document upon receiving an invocation of the first keystroke.

In another example, the method of may include obtaining, via the user interface, a second keystroke, associating the second keystroke with a second digital content, and wherein the computer executable program includes a randomization function configured to randomly insert one of the first digital content or the second digital content into the document upon receiving an invocation of a third keystroke corresponding to the randomization function. In another example, the computer executable program may include a count function configured to maintain a count of a number of times the first digital content has been inserted into the document. In another example, the electronic memory device is resident to one or more of: (i) a local hard drive corresponding to the user interface, or (ii) a remote internet server.

In another example, generating the user-defined keyboard may include obtaining, via the user interface, a second keystroke, associating the second keystroke with a second digital content, and storing the user defined keyboard in a remote internet server. In another example, the method may include communicating a request to the remote internet server, wherein the request is configured to retrieve the user-defined keyboard, retrieving, by the computer executable program, the stored user-defined keyboard, and utilizing the clipboard interface function to insert the first digital content or the second digital content into the document upon receiving an invocation of the first keystroke or the second keystroke, wherein the first digital content or the second digital content is retrieved from the remote internet server.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a conceptual diagram illustrating an example of a hardware implementation for an exemplary computing device or apparatus employing a processing system.

FIG. 2 is a block diagram of an example embodiment of a user interface in accordance with the disclosed subject matter.

FIG. 3 is a block diagram of an example embodiment of a graphical user interface main menu in accordance with the disclosed subject matter.

FIG. 4 is a block diagram of an example embodiment of a graphical user interface main menu having additional features in accordance with the disclosed subject matter.

FIG. 5 is a block diagram of an example embodiment of a graphical user interface submenu in accordance with the disclosed subject matter.

FIG. 6 is a flow chart illustrating an exemplary process for performing a clipboard interface function in accordance with the disclosed subject matter.

FIG. 7 is a flow chart illustrating another exemplary process for performing a clipboard interface function in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. While some examples may or may not be specifically directed to use cases or applications, a wide assortment of applicability of described innovations may occur.

Users of digital media will often perform an array of repetitive tasks. For example, a user may utilize a clipboard function to temporarily store and insert data into digital media. While the conventional clipboard function may include a capacity to store a set of data for later use, many repetitive tasks may require multiple sets of data. For example, a document editor may be required to review a volume of documents and provide comments on the document contents. In some cases, the editor may need to repeat multiple instances of multiple comments in each document. The editor's time may be more efficiently allocated by utilizing a method for rapid insertion of the multiple comments. In one embodiment, the user may utilize a web browser to review digital media content hosted by a website or web-based program, including but not limited to a Google Chrome® browser for reviewing a document hosted by Google Docs®. In such an embodiment, the user may utilize a web browser extension to facilitate efficient insertion into the document.

In this context, a “website” includes a file or document which is a publicly or privately accessible using Internet Protocol or is otherwise interpretable by any web browser. In various embodiments, such websites may include a file formatted as Hypertext Markup Language (HTML), Cascading Style Sheets (CSS), JavaScript, Extensible Markup Language (XML) such as a XHTML (Extensible HyperText Markup Language) file, an Adobe Flash file, Java Applets, images, videos, sounds, etc. In various embodiments, the website may include one or more web pages. For example, an HTML web page may be modified or include other web pages, such as, JavaScript, a CSS file, various images, etc. It is understood that the above is merely one illustrative example to which the disclosed subject matter is not limited.

In this context a web-based program may include a web app and may relate to any program that may include computer executable code as part of the website, as it is defined herein. A web browser may run the web-based application in full or in part. For example, the web-based program may involve client-server communication, where processing is done over the internet on a remote internet server or internet-accessible device. Google Docs® is one example of a web-based program.

In this context, a document may relate to word processing documents, spreadsheet documents, presentation documents, etc. In one example, the document may be opened or presented by one or more programs resident to a computing device including machine executable code and configured to be executed directly by a processor and/or an operating system on the computing device. Microsoft® Word® is one example of a program resident to a computing device. In another example, the document may be opened or presented by the web-based program configured to be executed or interpreted by the web browser. In another example, a document may include any digital medium configured to accept user input upon invocation of one or more keystrokes.

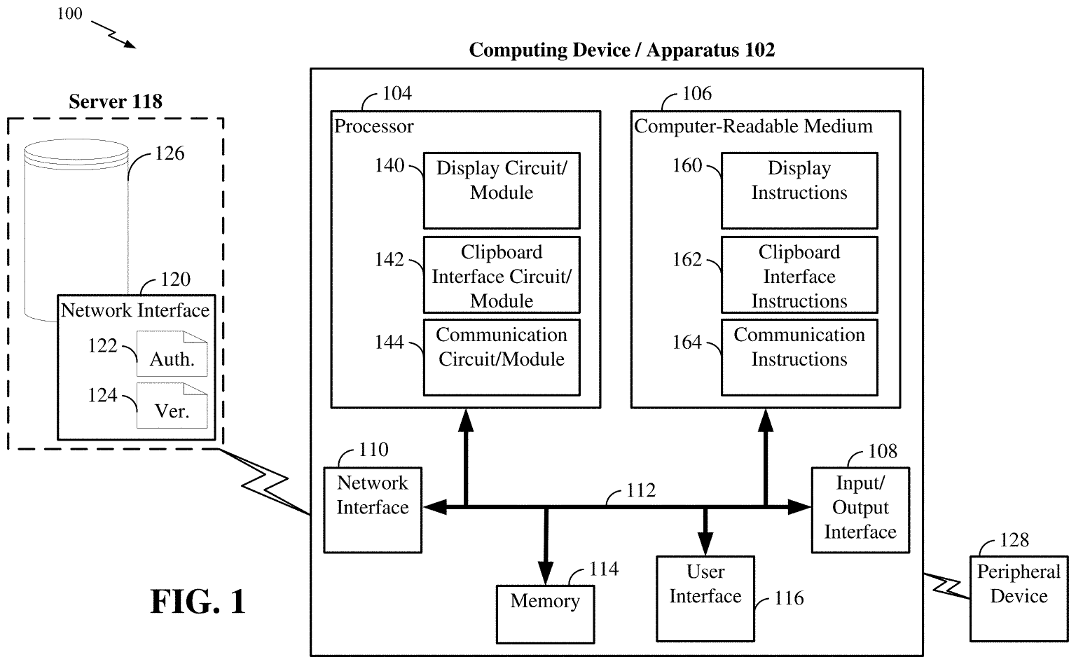

FIG. 1 is a conceptual diagram illustrating an example of a hardware implementation for an exemplary computing device 102 employing a processing system. The computing device 102 may be implemented with a processing system that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the computing device 102 may be configured to perform any one or more of the functions described herein. That is, the processor 104, as utilized in a computing device 102, may be used to implement any one or more of the processes, procedures, and functions described herein.

In this example, the processing system 104 may be implemented with a bus architecture, represented generally by the bus 112. The bus 112 may include any number of interconnecting buses and bridges depending on the specific application of the processing system 104 and the overall design constraints. The bus 112 communicatively couples together various circuits including one or more processors (represented generally by the processor 104), a memory 114, and computer-readable media (represented generally by the computer-readable medium 106). The bus 112 may also link various other circuits such as timing sources, peripherals, voltage regulators, and power management circuits, which are well known in the art, and therefore, will not be described any further. The bus 112 may include an interface that provides interoperability between the bus 112 and a first network interface 110. The network interface 110 provides a communication interface or means for communicating with various other apparatus over a transmission medium. Depending upon the nature of the apparatus, a user interface 116 (e.g., keypad, display, speaker, microphone, joystick) may also be provided. Of course, such a user interface 116 may be integrated into the computing device 102 via the bus 112, or may be connected via an input/output interface 108. The input/output interface 108 may support data communications including one or more of a wired connection port and/or a wireless connection port. Wireless connections may include Bluetooth piconet ports as standardized by the Bluetooth Special Interest Group, and HomeRF ports as standardized by the HomeRF Working Group, as well as infrared ports and any other short range radio links between the computing device 102 and other portable devices. According to aspects of the present disclosure, the term(s) ‘communicate’ and/or ‘communicating’ refer to transmission and/or reception. One of ordinary skill in the art will understand that many types of technologies may perform such communication without deviating from the scope of the present disclosure.

In example of FIG. 1 may also include a peripheral device 128 configured to communicate with the computing device 102. In one example, the communication may be performed over a wired or wireless communication method. In some examples, the peripheral device may include an electromagnetic and/or mechanical feedback mechanism configured to communicate a particular function to the computing device 102. Some non-limiting examples may include a mouse, keyboard, touch-screen interface, switch, or button. In some examples, the peripheral device 128 may communicate the particular function with the input/output interface 108, the user interface 116, or the network interface 110. As such, a keystroke may be mapped to an action allowing the user to paste or insert corresponding digital media, and/or it may initiate communication through an input/output interface 108 via the communication module 144 to send and/or receive data from a peripheral device. The peripheral device 128 may communicate using a serial connection, USB, ethernet etc. One of ordinary skill in the art will understand that many types of technologies may perform such communication without deviating from the scope of the present disclosure.

The first network interface 110 may support communication with one or more servers 118. The server 118 may include a second network interface 120 to support communication with the computing device 102. The second network interface 120 may include a means to support authentication 122 and verification 124 of the user of the computing device 102. The server 118 may determine the extent of accessibility of information stored on the server 118 based on the authentication and verification of the user. In one example, the user may be permitted limited access to certain keyboards and/or categories of keyboards. In this example, the server 118 may control the users access based on the authentication and verification of the user. In another example, the user may be permitted access to one or more user-defined keyboards and/or categories of keyboards for a limited duration of time. In yet another example, the user may be permitted to utilize a certain amount of storage space in the database 126. In these examples, the second network interface 120 may support secure transfer of stored information between the server 118 and the computing device 102 according to the user's credentials. In one example, the server 118 may store information in a memory or database 126.

In some aspects of the disclosure, the processor 104 may include clipboard interface module 142 configured for various functions, including, for example, receiving, storing, and retrieving user input. For example, the clipboard interface module 142 may be configured to implement one or more of the functions described throughout this disclosure.

In one example, the clipboard interface module 142 may receive a first user input from the user interface 116. The first user input may include digital content such as text. The text may include formatted and/or unformatted text. The text may also include a link to one or more elements of a web page, or a link to digital media stored in the memory 114 or database 126. For example, the first user input may include a markup language such as HTML that supports displaying a frame for rendering an image, video, and/or audio identified in the HTML language.

The clipboard interface module 142 may also receive a second user input from the user interface 116 wherein the second user input corresponds to the first user input. The second user input may include a single keystroke, or a combination of two or more keystrokes from an alphanumeric keyboard, number pad, touch screen interface, or software-interpreted sources (such as voice input, an on-screen keyboard, eye-tracking software, gamepads, etc.) The clipboard interface module 142 may generate a mapping between the digital content and the keystroke, and may store the mapping and user inputs in the memory 114. The first user input, the second user input, and the mapping between them may represent a user-defined keyboard that may be selectively activated by a user. As used herein, a keystroke may include a user input that can be differentiated from another user input. In one example, a keystroke may include a single depression of a key on a physical or virtual keyboard or a combination of keys on the keyboard. In another example, the keystroke may include an electromagnetic and/or mechanical feedback mechanism configured to indicate a particular function. In one example, a soldier utilizing communication relays including those used in tactical armor and other military or government operations may utilize an aspect of the body armor (i.e., the keystroke) to communicate digital media such as a location, an objective, or acknowledgment of received information. In another example, a student using voice dictation software to write an email may utilize a certain keyword or key phrase (i.e., the keystroke) to insert an image. One of ordinary skill in the art will understand that many types of technologies may perform such communication without deviating from the scope of the present disclosure.

In another example, the keystroke may include a voice command. In this example, the input/output interface 108 or peripheral device 128 may include an audio transceiver (e.g., microphone) configured to receive an analog auditory signal and convert the analog signal into a digital signal recognizable by the clipboard interface module 142. In this manner, the user may configure the computing device 102 to recognize certain auditory commands, and map those commands to a digital content. As such, the user may insert an array of digital content into a document using one or more auditory commands.

The clipboard interface module 142 may also communicate with a clipboard function resident to a web browser or other computer-executable program to facilitate insertion of the user provided digital content into a digital media. In this example, digital media may include anything that can accept or receive user input. In one example the user may open and view a document using the computing device 102. The user may select one or more portions or elements of the document and utilize the clipboard interface circuit 142 to quickly ‘paste’ or insert digital content into the selected portion of the document by simply actuating the keystroke(s) mapped to the digital content. In this example, the clipboard interface circuit 142 may communicate with the clipboard function resident to the application or program that renders the viewable document, and utilize that resident clipboard function to trigger a pasting function to insert the digital content into the document when the user actuates the corresponding keystroke.

The clipboard interface module 142 may also preserve data that was previously cut/copied by the resident clipboard function. For example, if the user copies data, then uses a keystroke to insert another data stored by the clipboard interface module 142, the clipboard interface module may retrieve the previously copied data prior to inserting the other data. Once the other data has been inserted, the clipboard interface module 142 may restore the copied data by moving the copied data back to the resident clipboard function. It should be noted that the copied data may be data that was copied or cut by a user using the resident clipboard function.

In another example, the user may open and view a document hosted by a website or web-based program using the computing device 102. The user may select one or more portions or elements of the document and utilize the clipboard interface circuit 142 to quickly paste digital content into the selected portion of the document by simply actuating the keystroke mapped to the digital content. In this example, the clipboard interface circuit 142 may communicate with the clipboard function resident to the browser that renders the viewable document, and utilize that resident clipboard function to trigger the pasting function to insert the digital content into the document when the user actuates the corresponding keystroke. The clipboard interface module 142 may further operate in coordination with the clipboard interface software 162. In one example, the clipboard interface software 162 may provide instructions for supporting the functionality disclosed herein.

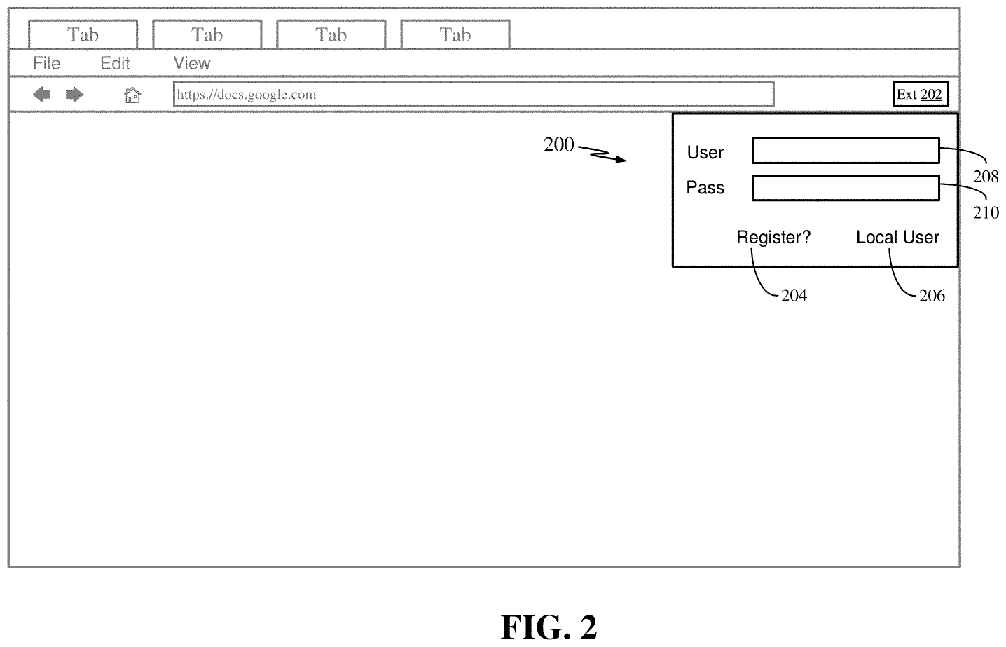

In some aspects of the disclosure, the processor 104 may include display module 140 configured for various functions, including, for example, displaying a document and a graphical user interface associated with the clipboard interface circuit 142. For example, the display module 140 may be configured to implement one or more of the functions described below in relation to FIGS. 2-6. The display module 140 may further operate in coordination with the display software 160. In one example, the display software 160 may transmit, receive, and provide instructions for processing the display of programs accepting user input and/or displaying documents, user inputs, and a graphical representation of the clipboard interface functionality.

In some aspects of the disclosure, the processor 104 may include communication module 144. The communication module 144 may include one or more hardware components that provide the physical structure that performs various processes related to user inputs, and internet and server 118 communication (e.g., signal reception, signal generation, and/or signal transmission) as described herein. The communication module 144 may further operate in coordination with the communication software 164. In one example, the communication software 164 may transmit, receive, and provide instructions for processing user inputs, and internet and server 118 communication. Throughout this disclosure, the functionality of the various circuits and software may be referred to collectively as a clipboard interface function.

The processor 104 is responsible for managing the bus 112 and general processing, including the execution of software stored on the computer-readable medium 106. The software, when executed by the processor 104, causes the processing system to perform the various functions described below for any particular apparatus. The computer-readable medium 106 and the memory 114 may also be used for storing data that is manipulated by the processor 104 when executing software.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 106 may reside in the computing device 102, external to the processor 104, or distributed across multiple entities including the processor 104. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

FIG. 2 is a block diagram of an example embodiment of a graphical user interface in accordance with the disclosed subject matter. More specifically, FIG. 2 illustrates an embodiment of a web browser extension 202 that may alter the functionality of a web browser. This example embodiment represents an optional feature that may allow a user access to a database containing additional information including saved keyboard mapping files and corresponding user input data.

In one embodiment, the browser extension 202 may cause the web browser to display an icon or other graphical user interface on a portion of the browser. In addition, the browser extension 202 may cause the web browser to respond or react to graphical user interface events (e.g., right-mouse click, key presses, etc.) that are associated with the added icon. If the extension 202 detects an appropriate user event, the browser extension 202 may cause a menu or other graphical user interface to be displayed. In the illustrated embodiment, an event may cause a login request 200 to be displayed. In various embodiments, the menu or other graphical user interface may include an HTML popup that may be created and controlled via scripted code that is included in the browser extension 202. It should be understood that such exemplary embodiments can be implemented in various devices, systems, and methods.

The example login request 200 may include one or more associated menu items such as a user identification field 208 and a password field 210. In this example, a user may be required to provide identifying information in order to access the database. Additional fields may also be displayed in order to establish identity of the user. For example, in an academic setting the login request 200 may require a user to identify their role as a student, an educator, teacher's assistant, etc. Other user data may be required, including acceptance of a terms of use agreement. The user may also have the option to register 204 an identity to establish a degree of access to the database. The user may also have the option to establish identity as a local user 206. The local user option may allow the user to utilize a user-defined keyboard stored on a local drive or memory 114. In this way the user will not be required to have or maintain an online presence. By using the local user 206 option, the user may be restricted to information that is stored in the local memory 114 such as user-defined information on a local disk or cached credentials acquired from online use. This provides a benefit that allows a user to utilize the clipboard function and the corresponding user-defined keyboards offline.

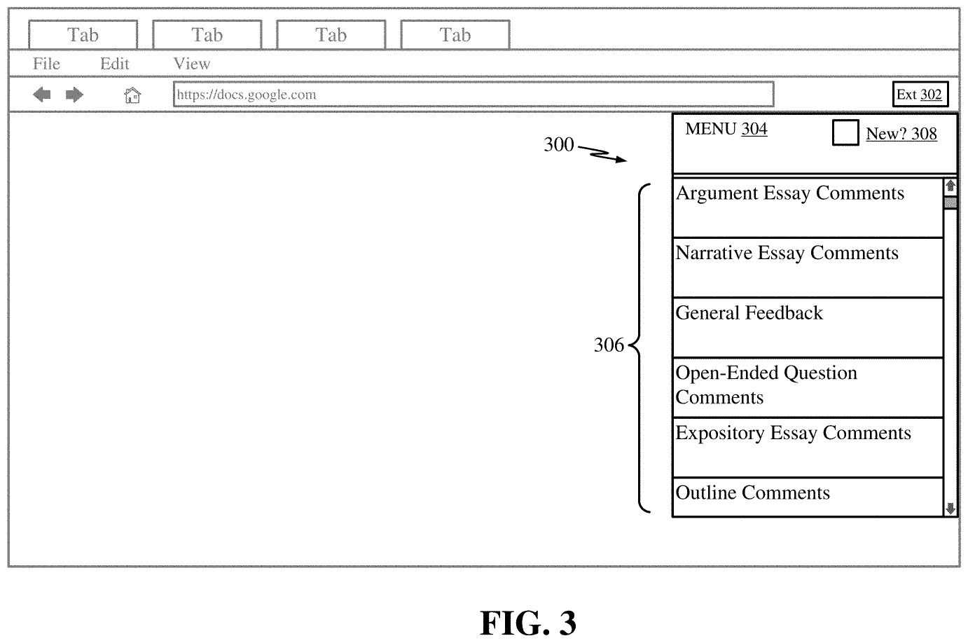

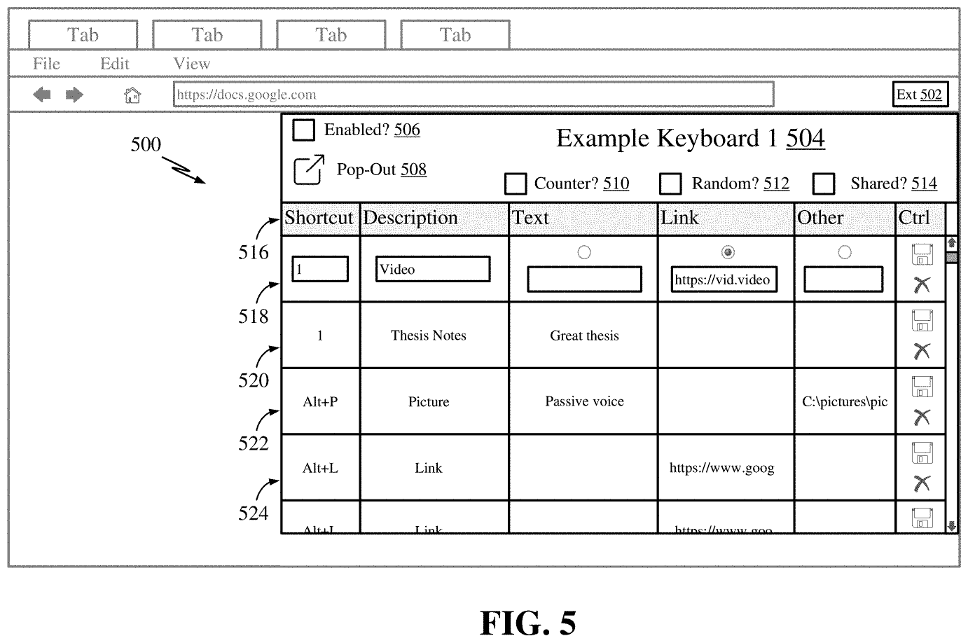

FIG. 3 is a block diagram of an example embodiment of a graphical user interface main menu 300 in accordance with the disclosed subject matter. The example main menu 300 may include one or more associated menu items such as a browser extension 302 icon, a user title field 304, one or more saved user-defined keyboards 306, and an option to create a new user-defined keyboard 308. As illustrated below in FIG. 5, each of the user-defined keyboards may include one or more instances of a digital content mapped to a corresponding keystroke. For example, the Argument Essay Comments is a graphical representation of a user-defined keyboard 306 displayed on a portion of the main menu 300. A user may select a particular keyboard by activating (i.e., activating with a cursor, voice command, or touch screen activation) this main menu 300 item. By allowing the user to organize multiple user-defined keyboards in this way, the user has the ability to switch between keyboards having different contexts.

For example, an educator may generate a user-defined keyboard titled Argument Essay Comments containing one or more keystrokes mapped to one or more comments or other digital content directed to a curriculum on argumentative or persuasive writing. Other user-defined keyboards 306 may be directed to curriculums having a different context, such as comments and other digital content directed to narrative essays, general feedback, open-ended questions, expository essays, and outlines. In this way, an educator may easily organize and access stored user-defined keyboards 306 based on the context of an assignment or class curriculum. While this example is directed to an academic application of this disclosure, it should be noted that the various concepts presented throughout this disclosure may be implemented across a broad variety of industries. In another example, a business owner may generate multiple user-defined keyboards 306 to map contact information of suppliers and consumers for quick insertion of the data into orders and invoices.

The main menu 300 may also allow a user to generate a new user-defined keyboard 308. Generating a new user-defined keyboard may allow a user to label and append a unique user-defined keyboard to the main menu, for which the user may generate a new list of digital content to keystroke mappings. Ability to generate a new user-defined keyboard 308 and/or to access one or more of the previously generated user-defined keyboards 306 may limited by the access level of the user. For example, an educator may login as an ‘Educator’ and may provide user identification information that provides the educator with full access to existing user-defined keyboards as well as the ability to generate new user-defined keyboards and save them in a server database 126 and/or on a local memory 114. In another example, a student may login as a ‘Student’ and provide user identification information that provides the student with a more restricted access. For example, the student may not be able to edit an existing user-defined keyboard or generate a new user defined keyboard 308, and may only be able to access certain of the existing user-defined keyboards 306.

In another example, a user may select which user-defined keyboards 306 populate the main menu 300. For example, while the server database 126 may include a plurality of user-defined keyboards, the user may select a limited portion of the plurality of user-defined keyboards to populate the main menu 300. This selection may also limit the access of another user.

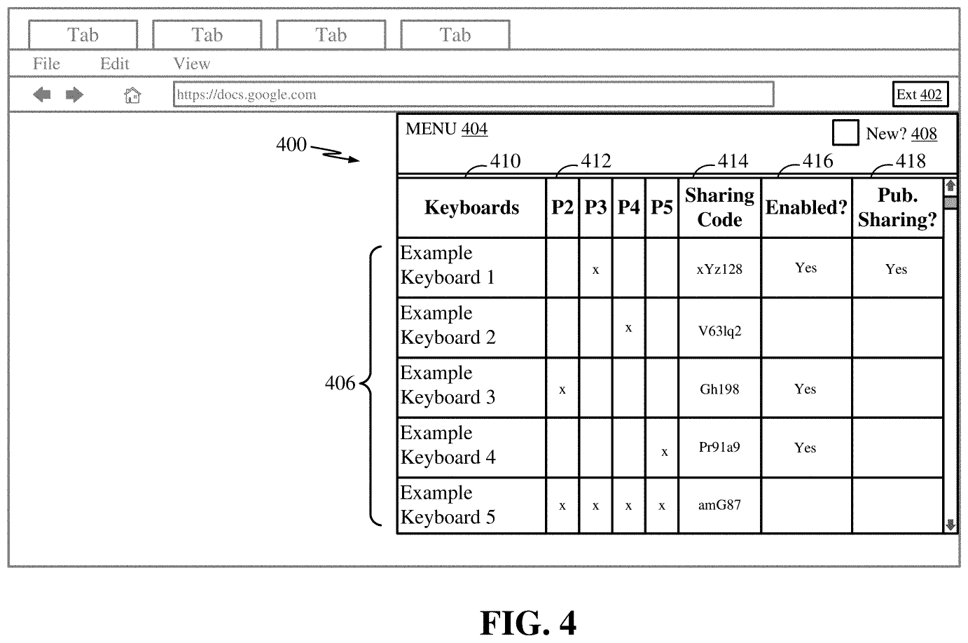

FIG. 4 is a block diagram of an example embodiment of a graphical user interface main menu 400 having additional features in accordance with the disclosed subject matter. The example main menu 400 may include one or more associated menu items such as a browser extension 402 icon, a user title field 404, one or more saved user-defined keyboards 406, an option to create a new user-defined keyboard 408, and a number of column identifiers. Each of the user-defined keyboards may include one or more instances of a digital content mapped to a corresponding keystroke. A user may select a particular keyboard by activating (i.e., activating with a cursor, voice command, or touch screen activation) this main menu 400 item. The main menu 400 may also include a number of columns for providing additional information associated with each user-defined keyboard.

In one embodiment, a keyboards column 410 may be included in the main menu 400. The keyboards column 410 may allow the user to sort the user-defined keyboards 406 that are visible to the user. Furthermore, keyboards can be collated into user-defined collections of user-defined keyboards and/or categories of user-defined keyboards. In another embodiment, one or more user-labeled columns 412 may be included in the main menu 400. The user-labeled columns 412 may be created and edited by a user with sufficient privileges, and may be utilized to assign certain accessibility privileges to groups of users. For example, in an academic setting, the user-labeled column 412 labeled P2 may be utilized to grant read only privileges to a specific class or group of students, and read and write privileges to an educator and and/or staff member associated with that specific class or group of students. Multiple columns 412 may be created and labeled by the user in order to organize accessibility privileges according to the needs and/or requirements of different groups.

In another embodiment, a sharing code column 414 may provide a sharing code associated with one or more of the user-defined keyboards 406 in the main menu 400. The sharing code may be a randomly generated code unique to a particular one or more keyboards, or may be a user generated code. The sharing code may only be visible to users having sufficient privileges. For example, a user may create a new user-defined keyboard and generate an associated sharing code. The user may then toggle visibility of the code based on certain groups of users and/or individual users. The sharing code allows the user to create a user-defined keyboard and determine what other users may have access to the keyboard. For example, the user may share the keyboard on an individual basis by simply providing the sharing code to another user.

In another embodiment, the main menu 400 may include an enabled column 416 configured to indicate whether the current user is enabled to access a particular user-defined keyboard 406. The current user, or an individual user's access may be defined by another user having sufficient rights access, or by the creator of the user-defined keyboard. In one example, the current user may be allowed access to certain of the user-defined keyboards based on the group(s) the user is associated with, or based on the user's log in credentials.

In another embodiment, the main menu 400 may include an enabled column 416 configured to indicate whether the current user has enabled access to sharing among a user or group of users particular user-defined keyboard 406. The current user, or an individual user's access may be defined by another user having sufficient rights access, or by the creator of the user-defined keyboard. In one example, the current user may be allowed access to certain of the user-defined keyboards based on the group(s) the user is associated with, or based on the user's log in credentials. In another example, the current user may select one or more user-labeled columns 412 associated with a user-defined keyboard or category of keyboards. In this example, the current user may use the enabled column 416 to share the user-defined keyboard or category of keyboards with the selected groups or users associated with the selected user-labeled columns 412.

FIG. 5 is a block diagram of an example embodiment of a graphical user interface submenu 500 in accordance with the disclosed subject matter. The example submenu 500 may be triggered by a user activating one or more portions of the main menu illustrated in FIGS. 3 and 4. The submenu 500 may include one or more associated menu items such as a browser extension 502 icon, a submenu title field 504, an option for enabling the one or more saved user-defined keyboards 506, an option to pop-out 508 and resize the submenu 500 to a new window or frame outside of the browser, an option for enabling a counter 510, an option for enabling randomization 512 of the user-defined keyboards, and an option for sharing 514 the user-defined keyboards. The submenu 500 may also include a number of columns 516 for providing additional information associated a selected user-defined keyboard.

In one example, the user may have selected a particular keyboard by activating (i.e., activating with a cursor or touch screen activation) “Example Keyboard 1” of the main menu 400 in FIG. 4. The selected keyboard may be labeled in the submenu title field 504. The submenu 500 may include a list of the user-defined key mappings included in the selected user-defined keyboard according to a number of columns 516. For example, the submenu columns 516 may include a Shortcut column. The shortcut column may include a user-defined keystroke or combination of keystrokes that are mapped to a particular digital content. The submenu columns 516 may also include a Description column configured to include a user-defined description of each particular keystroke mapping. The submenu columns 516 may also include a Text column configured to include a user-defined body of formatted or unformatted text representative of all or a portion of the digital content mapped to a particular keystroke. The submenu columns 516 may also include a Link column configured to include user-defined digital linking to additional subject matter. The digital linking may include uniform resource locator (URL) link data or another form of electronic address. The submenu columns 516 may also include a column labeled Other, configured to include other forms of digital content, including HTML code, video, sound, a data table, augmented reality data, virtual reality data, etc. Video, sound, and other digital content may be mapped to a selected keystroke via an address to a file location in the server database 126 or a local memory 114. The submenu columns 516 may also include a Control column configured to allow a user to delete or save a particular digital content to keystroke mapping. The control column may include one or more icons indicative of saving and deleting the mapping. As described below, a user-defined keyboard may include one or more user defined mappings that map a particular keystroke to digital content.

A first user-defined mapping 518 illustrated in FIG. 5 may include one or more fields for allowing a user to define a Shortcut, Description, Text, Link, or Other field for enabling and saving a user-defined mapping entry. For example, a second user-defined mapping 520 entry is an entry that has been saved and includes a shortcut keystroke defined as the number 1 and mapped to a textual entry reciting “Great thesis.” Thus, in one example, when Example Keyboard 1 504 is enabled, the user may select a position within a document and paste the text, “Great thesis” by simply entering a keystroke associated with the number 1 on a keyboard or other user interface. By entering the number 1, the clipboard interface function may utilize the clipboard function of the browser and/or document to paste or insert the mapped digital content (i.e., “Great thesis”) into the selected portion of the document. In some examples, digital content may be pasted into a comment, a text box, or other review type feature of the document so that a reader is able to distinguish between the text of the document and the text provided by the user.

A third user-defined mapping 522 illustrated in FIG. 5 may include a combination of keystrokes that map to a body of text as well as a graphic or picture. In this example, when Example Keyboard 1 504 is enabled, the user may select a position within a document and paste the text, “Passive voice” along with a picture by simply combining commands alt+P on a keyboard or other user interface. The combination of commands alt+P may trigger the clipboard interface function to utilize the clipboard function of the browser or document to paste or insert the mapped digital content (i.e., “Passive voice” and the picture) into the selected portion of the document. In this example, the graphic or picture may be retrieved by the clipboard interface function from a link to a location in a local memory (C:\pictures\pic). As in the previous example, digital content may be pasted into a comment, a text box, or other review type feature of the document so that a reader is able to distinguish between the text of the document and the text provided by the user.

In one example, the column labeled “other” may be configured to receive and store HTML code associated with an image or other media that may not be strictly text. For example, if a user copies in image, that copy may include HTML or other source code associated with the image. By pasting that source code into the text field of the ‘other’ column, a user may be able to insert the copied image into a document or other digital media using the associated keystroke. Digital media stored by the ‘other’ column may also include text formatting associated with text in any application or program. For example, a user may copy text being formatted with bold and red-colored text attributes, then paste the formatted text into the text box within the ‘other’ column. In this example, the user may insert the text into any document of digital media while maintaining the formatted attributes of the text. Thus, by actuating a keystroke or combination of keystrokes associated with the formatted text, the text and it's formatted attributes will be inserted. Although there are at most five keystrokes shown in FIG. 5, each user-defined keyboard may include N keystrokes, limited only by the user's computer memory and/or server memory, and processing capacity.

A fourth user-defined mapping 524 illustrated in FIG. 5 may include a combination of keystrokes that map to a website link. In this example, when Example Keyboard 1 504 is enabled, the user may select a position within a document and paste the website link by simply combining commands alt+L on a keyboard or other user interface. The combination of commands alt+L may trigger the clipboard interface function to utilize the clipboard function of the browser or document to paste or insert the mapped digital content (i.e., the link “http://www.goog”) into the selected portion of the document. As in the previous example, digital content may be pasted into a comment, a text box, or other review type feature of the document so that a reader is able to distinguish between the text of the document and the text provided by the user.

In one example, a user may enable a counter 510 configured to track or count a number of times that each user-defined mapping of a particular one or more user-defined keyboards is used. The counter 510 may be configured to track a number of uses in a single document, or a number of uses associated with a plurality of documents. The counter may also enable a user to track the number of times one or more user-defined keyboards are used. This provides the benefit of allowing a user to determine how often particular features of the clipboard interface function are used. In the example of a document editor, this provides the editor with information that can aid in understanding issues are frequently encountered so that the editor can address those issues with the author(s). The counter can also be accessed by a controlling user or administrator of the user-defined keyboard and/or category of keyboards. In one example, the controlling user may include an educator or newspaper editor. In another example, the controlling user may include a manager. The counter 510 may utilized by the manager to provide information regarding use statistics relating to the use of user-keyboards and/or the use of keystrokes by certain employees or groups of employees.

In another example, a user may enable randomization 512 of the user-defined mappings. In one example, a user may associate one or more single keystrokes and/or combination of keystrokes with the randomization function in order to facilitate entering one or more random user-defined mappings into a document each time the user activates the keystroke. For example, the user may dedicate keystroke combination ctrl+R with the randomization function. Here, each time the user activates the dedicated keystroke, digital content in the user-defined keyboard is randomly selected and inserted or pasted into the document via a clipboard function of the browser and/or document application.

In another example, a user may create and store a user-define keyboard on a server database 126, and the user may lock the keyboard to prevent other users from opening, deleting, and/or modifying the keyboard. The user may also lock only certain aspects of the keyboard to limit the extent to which others may modify the keyboard. In another embodiment, users may generate new keyboards based on existing keyboards and modify the new keyboards to suit their particular needs. The user may also enable a sharing function 514 of the keyboard to allow the keyboard to be shared with other users.

In the example of FIG. 5, the submenu 500 is illustrated as including multiple mappings corresponding to a user-defined keyboard called Example Keyboard 1 504. However, in another example, the submenu 500 may instead contain another list of one of more user-defined keyboards, each having an additional submenu containing additional user-defined keyboards and/or one or more mappings between a keystroke and a digital media. In this way, multiple categories and options for user-defined keyboard management may be realized.

The graphical user interfaces described in FIGS. 2-5 may be hosted by a website or a computer-executable program other than a web browser or web browser extension. For example, the server may host a website and execute computer readable instructions to provide a user with the graphical user interfaces. Using the same instructions, the server may receive and store data that the user provides by the interface.

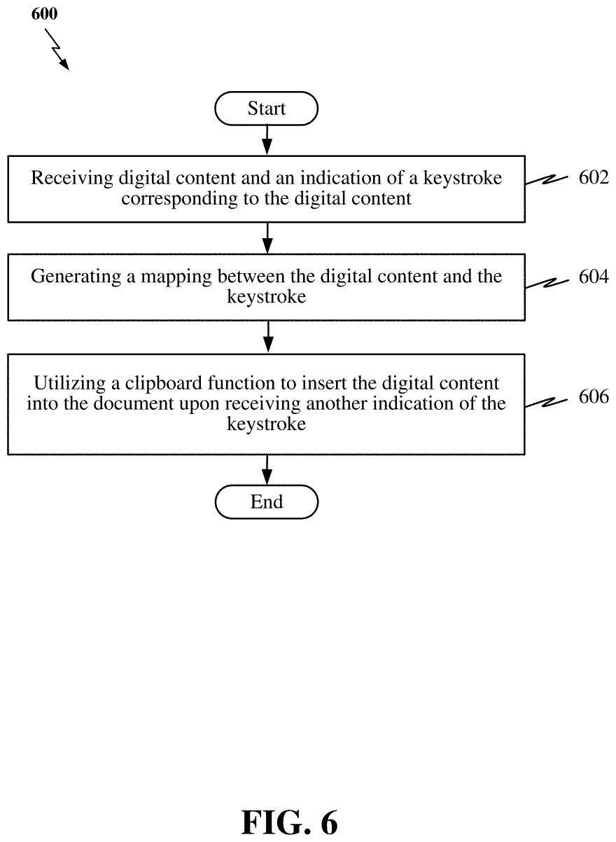

FIG. 6 is a flow chart illustrating an exemplary process 600 for performing a clipboard interface function in accordance with some aspects of the present disclosure. As described below, some or all illustrated features may be omitted in a particular implementation within the scope of the present disclosure, and some illustrated features may not be required for implementation of all embodiments. In some examples, the process 600 may be carried out by a server 118 and/or the computing device 102 illustrated in FIG. 1. In some examples, the process 600 may be carried out by any suitable apparatus or means for carrying out the functions or algorithms described below.

At block 602, the processor 104 may receive digital content and an indication of a keystroke corresponding to the digital content. In one example, the communication circuit 144 may provide a means for communicating the digital content and the indication of a keystroke from a user interface 116 to the processor 104. In another example, the clipboard interface circuit may store the keystroke and the digital content in the memory 114 or server database 126.

At block 604, the processor 104 may generate a mapping between the digital content and the keystroke. In one example, the clipboard interface circuit 142 may generate the mapping and store the mapping in the memory 114 or server database 126.

At block 606, the processor 104 may communicate with an application or program to facilitate utilization of a clipboard function of the application or program to insert the digital content into the document upon receiving another indication of the keystroke. In one example, the clipboard interface circuit 142 may communicate with the clipboard function of the application or program to facilitate insertion of the digital content that has been stored in the memory 114 or the server database 126.

In one configuration, the apparatus 102 for facilitating a clipboard interface function includes means for receiving digital content and an indication of a keystroke corresponding to the digital content, means for generating a mapping between the digital content and the keystroke, and means for utilizing a clipboard function to insert the digital content into the document upon receiving another indication of the keystroke. In one aspect, the aforementioned means may be the processor(s) 104 shown in FIG. 1 configured to perform the functions recited by the aforementioned means. In another aspect, the aforementioned means may be a circuit or any apparatus configured to perform the functions recited by the aforementioned means.

Of course, in the above examples, the modules included in the processor 104 are merely provided as an example, and other means for carrying out the described functions may be included within various aspects of the present disclosure, including but not limited to the instructions stored in the computer-readable storage medium 106, or any other suitable apparatus or means described herein.

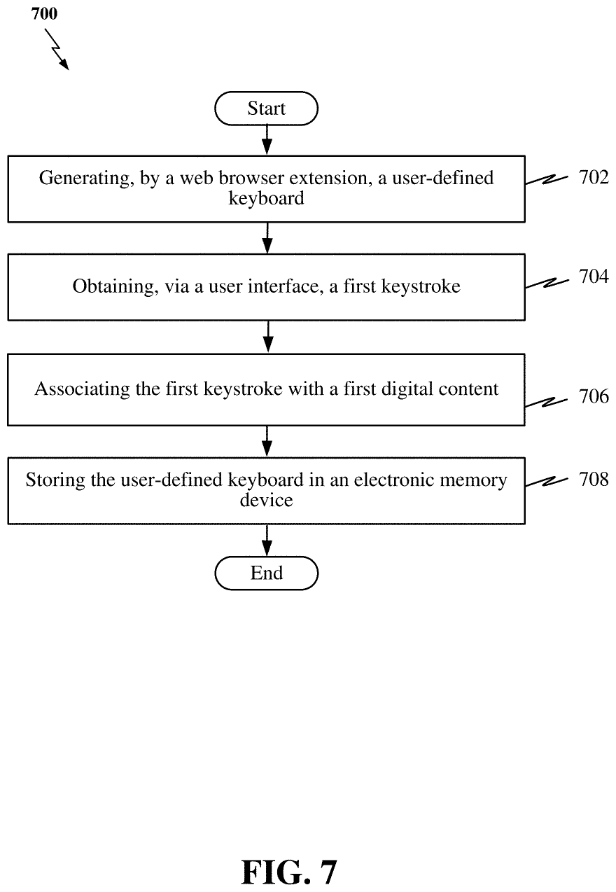

FIG. 7 is a flow chart illustrating another exemplary process 700 for performing a clipboard interface function in accordance with some aspects of the present disclosure. As described below, some or all illustrated features may be omitted in a particular implementation within the scope of the present disclosure, and some illustrated features may not be required for implementation of all embodiments. In some examples, the process 700 may be carried out by the server 118 and/or the computing device 102 illustrated in FIG. 1. In some examples, the process 700 may be carried out by any suitable apparatus or means for carrying out the functions or algorithms described below.

At block 702, the processor 104 may generate a user-defined keyboard. In one example, the processor 104 may execute a web browser extension configured to receive data input including a first keystroke and a first digital content. In one example, a user may utilize the user interface 110 to communicate the first keystroke and the digital content to the web browser extension. In another example, the processor 104 may execute a locally installed application that provides the user interface 110, allowing the user to communicate the first keystroke and digital content to the locally installed application. The processor 104 may be configured to map an association between the first keystroke and the first digital content. As illustrated in FIG. 5, the user may utilize the user interface 110 to provide additional information.

At block 704, the processor 104 may obtain a first keystroke via the user interface 110. At block 706, the processor 104 may associate the first keystroke with the first digital content. In one example, the processor 104 may generate a look-up table for associating the first keystroke with the first digital content.

At block 708, the processor 104 may store the user-defined keyboard and the mapping in an electronic memory device. In one example, the electronic memory device may include one or more of a local memory 114 or a server database 126.

In one exemplary embodiment, a first user may utilize a first computing device (e.g., the computing device 102 in FIG. 1) to execute a web browser. The first user may then launch a web browser extension configured to generate a user defined keyboard according to blocks 702-708. In this example, the first user may determine to associate a plurality of digital content with a plurality of keystrokes. For example, a first digital content may be associated with a first keystroke (e.g., a single keystroke corresponding to the number 1). In another example, a second digital content may be associated with a second keystroke (e.g., a combination of keystrokes corresponding to an “alt” key and the number 1). The user may store the user-defined keyboard in the server database 126.

At a later time, another user may utilize a second computing device (e.g., the computing device 102 in FIG. 1) to execute a web browser. The second user may then launch the web browser extension. The second user may utilize the web browser extension to retrieve the stored user-defined keyboard created by the first user if shared and enabled. Using the web browser, the second user may open a document using a web based program operable on the web browser. The second user may then insert the first digital content and/or the second digital content into the document by invoking the associated keystroke.

In one example, the web browser extension may be configured to modify an operation of a resident clipboard function included by the web browser. For example, a web browser may have a resident clipboard function configured to copy selected data upon the invocation of a combination of keystrokes, store the copied data in a temporary storage location, then paste or insert the copied data upon invocation of a different combination of keystrokes. Using the processor 104, the web extension may appropriate certain functions of the resident clipboard function. For example, if a user invokes one of the keystrokes associated with the user-defined keyboard, the web extension may communicate the digital media associated with the keystroke to the web browser, and execute a pasting function of the resident clipboard to paste the digital media associated with the keystroke. One of the benefits of this arrangement is the reduced memory requirements for the resident clipboard function of the web browser. For example, upon invocation of a keystroke, the web browser extension may retrieve the associated digital media from the database 126 of the server 118 or local memory 114. In another embodiment, the web browser extension may provide a storage address to the resident clipboard function so that the resident clipboard function may retrieve the associated digital media and insert it into the document without having to store the media in a cache or other digital repository associated with the resident clipboard function. Another benefit is the increased amount of digital media and keystrokes that may be utilized via the resident clipboard function.

In another example, the locally-installed program may be configured to modify an operation of the operating system's resident clipboard function. For example, if a user invokes one of the keystrokes associated with the user-defined keyboard, the operating system may communicate the digital media associated with the keystroke to any computer program accepting user input (including document editors like Microsoft Word® or Adobe Acrobat®, command lines like BASH and Microsoft PowerShell®, integrated developer environments like IntelliJ IDEA®, plain text editors like Notepad++, etc.) and execute a pasting function of the resident clipboard to paste the digital media associated with the keystroke. This approach has similar benefits to those outlined herein, but at the level of the operating system instead of web browser.

Of course, in the above examples, the use of a web browser and web browser extension for utilizing the modules included in the processor 104 are merely provided as an example, and other means for carrying out the described functions may be included within various aspects of the present disclosure, including but not limited to the using an executable program stored on the computing device (e.g., an Adobe® product such as Photoshop® or Reader®, a Microsoft® product, or any other executable program for viewing and editing digital files).

Within the present disclosure, the words “example” and “exemplary” are used to mean “serving as an example, instance, or illustration.” Any implementation or aspect described herein as an “example” or as “exemplary” are not necessarily to be construed as preferred or advantageous over other aspects of the disclosure. Likewise, the term “aspects” does not require that all aspects of the disclosure include the discussed feature, advantage or mode of operation. The terms “circuit,” “circuitry,” and “module” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-7 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-7 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of editing content in a document by an apparatus, comprising:
generating a user-defined keyboard, wherein generating the user-defined keyboard includes:
obtaining, via a user interface, a first keystroke, and
associating the first keystroke with a first digital content; and
storing the user-defined keyboard in an electronic memory device.

2. The method of claim 1, further comprising:
executing, by a processor included by the apparatus, a computer executable program containing a clipboard interface function, wherein the clipboard interface function is configured to modify an operation of a resident clipboard function included by an operating system;
retrieving, by the computer executable program, the stored user-defined keyboard; and
utilizing the clipboard interface function to insert the first digital content into a document upon receiving an invocation of the first keystroke.

3. The method of claim 2, wherein generating the user-defined keyboard further comprises:
obtaining, via the user interface, a second keystroke;
associating the second keystroke with a second digital content; and
wherein the computer executable program includes a randomization function configured to randomly insert one of the first digital content or the second digital content into the document upon receiving an invocation of a third keystroke corresponding to the randomization function.

4. The method of claim 2, wherein the computer executable program includes a count function configured to maintain a count of a number of times the first digital content has been inserted into the document.

5. The method of claim 2, further comprising:
retrieving copied data stored by the resident clipboard function;
replacing the copied data with the first digital content;
inserting the first digital content into a document upon receiving an invocation of the first keystroke; and
restoring the copied data stored by the resident clipboard function.

6. The method of claim 2, wherein the clipboard interface function includes a graphical user interface hosted by a remote server, and wherein the graphical user interface is presented by one or more of a web-page or the computer executable program.

7. The method of claim 2, wherein generating the user-defined keyboard further comprises:
obtaining, via the user interface, a second keystroke;
associating the second keystroke with a second digital content; and
storing the user defined keyboard in a remote internet server.

8. The method of claim 7, further comprising:
communicating a request to the remote internet server, wherein the request is configured to retrieve the user-defined keyboard;
retrieving, by the computer executable program, the stored user-defined keyboard; and
utilizing the clipboard interface function to insert the first digital content or the second digital content into the document upon receiving an invocation of the first keystroke or the second keystroke, wherein the first digital content or the second digital content is retrieved from the remote internet server.

9. The method of claim 1, wherein the electronic memory device is resident to one or more of: (i) a local hard drive corresponding to the user interface, or (ii) a remote internet server.

10. An apparatus for editing content in a document, comprising:
means for generating a user-defined keyboard, wherein the means for generating the user-defined keyboard includes:
means for obtaining a first keystroke, and
means for associating the first keystroke with a first digital content; and
means for storing the user-defined keyboard in an electronic memory device.

11. The apparatus of claim 10, further comprising:
means for executing a computer executable program containing a clipboard interface function, wherein the clipboard interface function is configured to modify an operation of a resident clipboard function included by an operating system;
means for retrieving the stored user-defined keyboard; and
means for utilizing the clipboard interface function to insert the first digital content into a document upon receiving an invocation of the first keystroke.

12. The apparatus of claim 11, further comprising means for maintaining a count of a number of times the first digital content has been inserted into the document.

13. The apparatus of claim 10, wherein the means for generating the user-defined keyboard further comprises:
means for obtaining a second keystroke;
means for associating the second keystroke with a second digital content; and
means for randomly inserting one of the first digital content or the second digital content into the document upon receiving an invocation of a third keystroke corresponding to a randomization function.

14. A non-transitory computer-readable medium storing computer-executable code, comprising code for causing a computer to:
generate a user-defined keyboard, wherein generating the user-defined keyboard includes:
obtaining a first keystroke, and
associating the first keystroke with a first digital content; and
storing the user-defined keyboard in an electronic memory device.

15. The non-transitory computer-readable medium of claim 14, further comprising code for causing the computer to:
execute a computer executable program containing a clipboard interface function, wherein the clipboard interface function is configured to modify an operation of a resident clipboard function included by an operating system;
retrieve the stored user-defined keyboard; and
utilize the clipboard interface function to insert the first digital content into a document upon receiving an invocation of the first keystroke.

16. The non-transitory computer-readable medium of claim 15, wherein the code configured to generate the user-defined keyboard is further configured to:
obtain, via a user interface, a second keystroke;
associate the second keystroke with a second digital content; and
randomly insert one of the first digital content or the second digital content into the document upon receiving an invocation of a third keystroke corresponding to a randomization function.

17. The non-transitory computer-readable medium of claim 15, wherein the computer executable program includes a count function configured to maintain a count of a number of times the first digital content has been inserted into the document.

18. The non-transitory computer-readable medium of claim 14, wherein the electronic memory device is resident to one or more of: (i) a local hard drive corresponding to a user interface, or (ii) a remote internet server.

19. An apparatus for editing content in a document, comprising:
a processor;
a transceiver communicatively coupled to at least one processor; and
a memory communicatively coupled to the at least one processor,
wherein the processor is configured to:
generate a user-defined keyboard, wherein generating the user-defined keyboard includes:
obtaining a first keystroke, and
associating the first keystroke with a first digital content; and
store the user-defined keyboard in an electronic memory device.

20. The apparatus of claim 19, wherein the processor is further configured to:
execute a computer executable program containing a clipboard interface function, wherein the clipboard interface function is configured to modify an operation of a resident clipboard function included by an operating system;
retrieve, by the computer executable program, the stored user-defined keyboard; and
utilize the clipboard interface function to insert the first digital content into a document upon receiving an invocation of the first keystroke.
